(19) United States
(12) Patent Application Publication
(10) Pub. No.: US 2013/0036970 A1
(43) Pub. Date: Feb. 14, 2013

(54) Substrate Processing Apparatus

(71) Applicants: Sun Hong Choi, Pyeongtaek-si (KR); Kwang Man Ko, Gwangju-si (KR); Seung Hun Lee, Gwangju-si (KR); Seung Ho Lee, Gwangju-si (KR); Ho Chul Lee, Seongnam-si (KR)

(72) Inventors: Sun Hong Choi, Pyeongtaek-si (KR); Kwang Man Ko, Gwangju-si (KR); Seung Hun Lee, Gwangju-si (KR); Seung Ho Lee, Gwangju-si (KR); Ho Chul Lee, Seongnam-si (KR)

(73) Assignee: JUSUNG ENGINEERING CO., LTD., Gwangju-si (KR)

(21) Appl. No.: 13/641,694

(22) PCT Filed: Apr. 14, 2011
(86) PCT No.: PCT/KR2011/002658

§ 371 Date: Oct. 16, 2012

(30) Foreign Application Priority Data
Apr. 19, 2010 (KR) 10-2010-0036085

(51) Int. Cl. B05C 13/00

(52) U.S. Cl. 118/500

(57) ABSTRACT

A substrate processing apparatus for deposition on a water seated therein is disclosed. The substrate processing apparatus includes a chamber having a reaction space, a lid provided on the chamber to selectively open or close the reaction space, a main disc accommodated in the chamber, on which at least one wafer is placed, and a drive device including a drive shaft to selectively rotate the main disc and a drive unit to drive the drive shaft. The drive shaft is separably coupled to the main disc to transmit drive force. When the lid is opened to expose the reaction space, the main disc is separated from the drive shaft and is discharged to the outside of the chamber in a state in which the wafer is placed thereon.

### TECHNICAL FIELD

The present invention relates to a substrate processing apparatus for deposition on a wafer seated therein.

### BACKGROUND ART

In general, fabrication of semiconductor devices includes, e.g., a process of forming a circuit pattern on a silicon wafer, and a packaging process of cutting the wafer to a predetermined size and packaging the substrate with an epoxy resin envelope, etc.

Forming the circuit pattern on the wafer requires a series of processes including deposition of a thin film having a predetermined thickness, photolithography for applying a photoresist to the deposited thin film and forming a photoresist pattern via exposure and developing, etching to pattern the thin film using the photoresist pattern, ion implantation to implant particular ions into a predetermined region of the wafer, and washing for removal of impurities. These processes are performed within a process chamber in which an optimum environment for the corresponding process is created.

In addition, semiconductor wafers, organic wafers and solar-cell wafers are fabricated by depositing a plurality of thin film layers on a wafer and etching the deposited thin film layers, to have desired characteristics.

Of the aforementioned processes, thin film deposition may be broadly classified into Physical Vapor Deposition (PVD) using physical collision, such as sputtering, and Chemical Vapor Deposition (CVD) using chemical reaction. Generally, CVD is more frequently used because CVD has superior thickness uniformity and step coverage ability than PVD. CVD may include Atmospheric Pressure CVD (APCVD), Low Pressure CVD (LPCVD), Plasma Enhanced CVD (PECVD), and Metal Organic CVD (MOCVD).

Of the several CVDs, MOCVD is CVD using metallic organic compounds, in which metallic organic compound steam is supplied at a high pressure to a surface of a heated wafer in a chamber having a reaction space, thereby forming a thin film on the surface of the wafer. MOCVD has advantages of causing no damage to the wafer or a crystalline surface and of reducing process time owing to relatively fast deposition rate.

Deposition of thin films performed has a limit in the thickness of a thin film obtained via one cycle and therefore, should be repeatedly performed several tens to hundreds of times to obtain a required film thickness, resulting in an extremely slow process rate.

Thus, to enhance deposition productivity, conventionally; a plurality of wafers is seated on a single main disc directly or with auxiliary susceptors interposed therebetween.

In particular, with regard to MOCVD, discharge of each wafer is generally performed by lifting and discharging a plurality of wafers placed on a single main disc one by one after completion of deposition, or by discharging each auxiliaty susceptor on which each wafer is placed.

Discharging the wafers or the auxiliary susceptors one by one requires enormous discharge time because the number of the wafers is great, causing serious deterioration in the discharge efficiency of the wafers.

### DISCLOSURE

### Technical Problem

An object of the present invention devised to solve the problem lies in a substrate processing apparatus in which an entire main disc, which is accommodated in a deposition process chamber to support a plurality of wafers seated thereon for deposition, can be discharged to the outside of the chamber after completion of deposition.

### Technical Solution

The object of the present invention can be achieved by providing a substrate processing apparatus including a chamber having a reaction space, a lid provided on the chamber to selectively open or close the reaction space, a main disc accommodated in the chamber, on which at least one wafer is placed, and a drive device including a drive shaft to selectively rotate the main disc and a drive unit to drive the drive shaft, wherein the drive shaft is separably coupled to the main disc to transmit drive force, and when the lid is opened to expose the reaction space, the main disc is separated from the drive shaft and is discharged to the outside of the chamber in a state in which the wafer is placed thereon.

The drive unit may raise the drive shaft so as to raise the main disc upon discharge of the main disc.

When the lid is lifted to open the chamber, the lid may grip the main disc so as to be lifted along with the main disc.

The lid may include at east one grip unit having a grip arm to selectively grip the main disc.

The grip arm may be horizontally movable to support a lower surface of the main disc only during discharge of the main disc.

The grip arm may be coupled to a lower position of the lid, or be integrally formed with the lid.

A height of an upper end of the chamber may be less than a height of a lower surface of the main disc.

The lid pray include a support unit to support an upper surface of the main disc, the support unit being rotated along with the maim disc during rotation of the main disc.

The support unit may include a support shaft extending from the lid to the upper surface of the main disc, an elastic member to provide the support shaft with elastic force, and a support cover placed on the lid to support the support shaft and the elastic member.

The support unit may further include a cooling member to cool the support shaft or the elastic member.

A drive gear may be provided at an upper end of the drive shaft, and a seating recess into which the drive gear is seated may be formed in a lower surface of the main disc, the seating recess being formed at a lateral surface thereof with a gear groove to be engaged with the drive gear.

The lid may be provided at a lower end thereof an opening for introduction of a robot arm upon discharge of the main disc, and the chamber may be provided at an upper end thereof with an extended portion to be engaged with the opening so as to close the opening when the lid covers the chamber.

The lid may include one or more grip units each having a grip arm to selectively grip the main disc, the grip units being spaced apart from one another on a lateral surface of the lid except for the opening.

In accordance with another aspect of the present invention, there is provided a substrate processing apparatus including a chamber having a reaction space for wafer deposition, a main disc rotatably mounted in the reaction space, and a drive shaft separably coupled to a lower face of the main disc to selectively rotate or vertically move the main disc, wherein the chamber is opened upon discharge of the main disc.

If a height of the main disc is less than a height of an upper end of the chamber during wafer deposition, the drive shaft may be raised such that the height of the main disc becomes greater than the height of the upper end of the chamber upon discharge of the main disc.

The substrate processing apparatus may further include a lid provided on the chamber to selectively open or close the reaction space, the lid serving to pull the main disc to a height higher than the upper end of the chamber upon discharge of the main disc.

In accordance with a further aspect of the present invention, there is provided a substrate processing apparatus including a chamber having a reaction space and provided at a lateral surface thereof with an opening, a main disc accommodated in the chamber, on which at least one wafer is placed, and a drive device including a drive shaft to selectively rotate the main disc and a drive unit to drive the drive shaft, wherein the drive shaft is separably coupled to the main disc to transmit drive force, and the main disc is separated from the drive shaft and is discharged to the outside of the chamber through the opening of the chamber in a state in which the wafer is placed thereon.

The opening of the chamber may be selectively opened or closed by a cover member slidably mounted to the lateral surface of the chamber.

The substrate processing apparatus may further include a valve assembly including valve housing provided at the opening and a blade mounted in the valve housing to selectively open or close the opening of the chamber.

The blade of the valve assembly may include a sealing member.

### Advantageous Effects

A substrate processing apparatus according to the present invention has the effect of discharging an entire main disc, which is accommodated in a deposition process chamber to support a plurality of wafers seated thereon for deposition, to the outside of the chamber after completion of deposition.

Further, the substrate processing apparatus according to the present invention can achieve remarkably increased discharge efficiency of the wafers as compared to discharging the wafers or auxiliary susceptors individually.

Furthermore, in the substrate processing apparatus according to the present invention, as a result of simultaneously discharging a plurality of wafers, temperature deviation between the respective wafers caused when the wafers or the auxiliary susceptors are discharged individually can be minimized, which prevents deterioration in the quality of thin films.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates an embodiment of a substrate processing apparatus according to the present invention.

FIG. 2 illustrates another operational state of the substrate processing apparatus according to the present invention.

FIG. 3 illustrates another embodiment of the substrate processing apparatus according to the present invention.

FIG. 4 illustrates another operational state of the substrate processing apparatus illustrated in FIG. 3.

FIG. 5 illustrates another embodiment of the substrate processing apparatus according to the present invention.

FIG. 6 illustrates another operational state of the substrate processing apparatus illustrated in FIG. 5.

FIG. 7 illustrates another embodiment of the substrate processing apparatus according to the present invention.

FIG. 8 illustrates another operational state of the substrate processing apparatus illustrated in FIG. 7.

FIG. 9 illustrates another embodiment of the substrate processing apparatus according to the present invention.

FIG. 10 illustrates another operational state of the substrate processing apparatus illustrated in FIG. 9.

FIG. 11 illustrates another operational state of the substrate processing apparatus illustrated in FIG. 9.

FIG. 12 illustrates another operational state of the substrate processing apparatus illustrated in FIG. 9.

FIG. 13 illustrates another embodiment of the substrate processing apparatus according to the present invention.

FIG. 14 illustrates another operational state of the substrate processing apparatus illustrated in FIG. 13.

FIG. 15 illustrates another operational state of the substrate processing apparatus illustrated in FIG. 13.

FIG. 16 illustrates another operational state of the substrate processing apparatus illustrated in FIG. 13.

FIG. 17 illustrates another embodiment of the substrate processing apparatus according to the present invention.

FIG. 18 illustrates another operational state of the substrate processing apparatus illustrated in FIG. 17.

FIG. 19 illustrates another embodiment of the substrate processing apparatus illustrated in FIG. 17.

FIG. 20 illustrates another embodiment of the substrate processing apparatus according to the present invention.

FIG. 21 illustrates another operational state of the substrate processing apparatus illustrated in FIG. 20.

FIG. 22 illustrates another operational state of the substrate processing apparatus illustrated in FIG. 20.

FIG. 23 illustrates another operational state of the substrate processing apparatus illustrated in FIG. 20.

FIG. 24 illustrates another embodiment of the substrate processing apparatus according to the present invention.

FIG. 25 illustrates another operational state of the substrate processing apparatus illustrated in FIG. 24.

FIG. 26 illustrates another embodiment of the substrate processing apparatus according to the present invention.

FIG. 27 illustrates another operational state of the substrate processing apparatus illustrated in FIG. 26.

FIG. 28 illustrates another embodiment of the substrate processing apparatus according to the present invention.

FIG. 29 illustrates another operational state of the substrate processing apparatus illustrated in FIG. 28.

FIGS. 30a and 30b illustrate examples of a drive shaft of the substrate processing apparatus according to the present invention.

### BEST MODE

Reference will now be made in detail to the preferred embodiments of the present invention, examples of which are illustrated in the accompanying drawings. The present invention may, however, be embodied in many alternate forms and should not be construed as limited to the embodiments set forth herein. Rather, these exemplary embodiments are provided so that this disclosure will be thorough and complete, and will fully convey the scope to those skilled in the art. The same reference numbers will be used throughout the drawings to refer to the same or like parts.

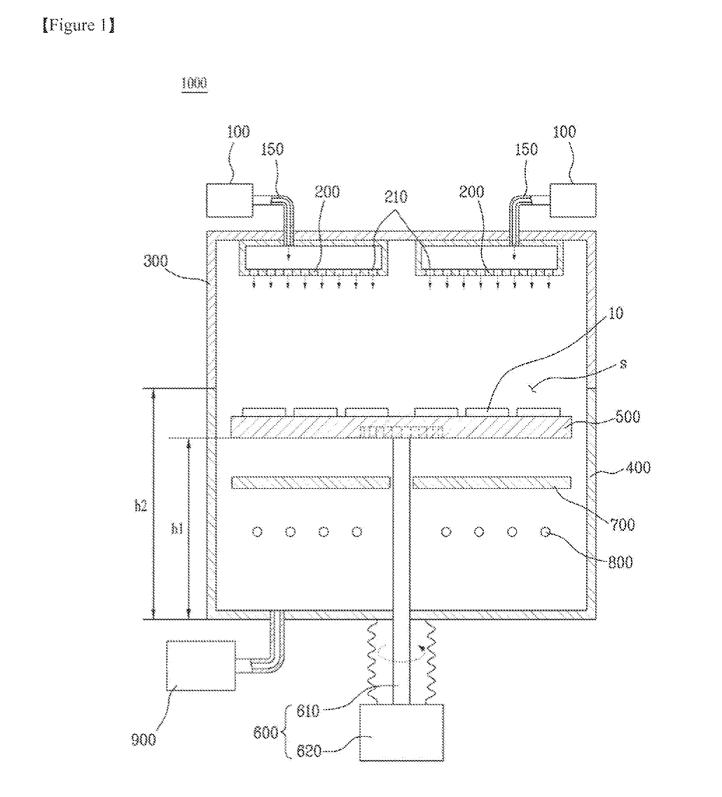

FIG. 1 illustrates an embodiment of a substrate processing apparatus 1000 according to the present invention.

The substrate processing apparatus 1000 includes a chamber 400 having a reaction space s, a lid 300 provided on the chamber 400 to selectively open or close the reaction space s, a main disc 500 accommodated in the chamber 400, on which one or more wafers 10 are seated, and a drive device 600 including a drive shaft 610 to selectively rotate the main disc 500 and a drive unit 620 to drive the drive shaft 610.

The drive shaft 610 is separably coupled to the main disc 500 to transmit drive force. When the lid 300 is opened to expose the reaction space s, the main disc 500 is discharged to the outside of the chamber 400 in a state in which the wafers 10 are seated on the main disc 500.

The substrate processing apparatus 1000 has a feature of discharging the entire main disc 500 on which the wafers 10 or auxiliary susceptors are seated, rather than discharging the wafers 10 or the auxiliary susceptors individually as in a conventional substrate processing apparatus. Recently, the main disc 500 is increasing in size.

Thus, the substrate processing apparatus 1000 includes the lid 300 to selectively open or close the reaction space s of the chamber 400.

When the lid 300 is opened, the main disc 500 on which the wafers 10 are seated can be discharged from the chamber 400.

A detailed method for discharging the main disc 500 will be described hereinafter.

The chamber 400 having the reaction space s for wafer deposition is configured to be opened during discharge of the main disc 500.

A gas feeding unit 100 may be provided at the lid 300 to provide the main disc 500 with process gas.

Specifically, the gas feeding unit 100 feeds the process gas into a gas injection unit 200 to uniformly inject the process gas over the plurality of wafers 10.

The gas feeding unit 100 and the gas injection unit 200 may be connected to each other via gas feeding pipes 150.

The gas injection unit 200 may be coupled to the lid 300 which shields the top of the chamber 400.

The gas injection unit 200 may have a plurality of injection holes 210. The gas injection unit 200 having the plurality of injection holes 210 can ensure uniform injection of the process gas.

The chamber 400 approximately takes the form of a barrel internally defining an interior space. Effectively, the chamber 400 may have a cylindrical or polygonal barrel shape.

The main disc 500, on which the wafers 10 are seated, is rotatably installed in the reaction space s of the chamber 400.

The main disc 500 is driven by the drive shaft 610 separably coupled to a lower surface thereof.

The drive unit 620 to drive the drive shaft 610 is connected to a lower end of the drive shaft 610.

The drive unit 620 may vertically move or rotate the drive shaft 610. Specifically, the drive unit 620 may include a motor to rotate the drive shaft 610.

The substrate processing apparatus 1000 may include a heater 800 accommodated in the chamber 400 to heat the wafers 10 placed on the main disc 500.

In the embodiment according to the present invention illustrated in FIG. 1, the heater 800 is located below the main disc 500.

The heater 800 may include a plurality of concentric rings. The heater 800 may be a high-frequency electric heater to be operated based on electromagnetic induction of high-frequency current, or an infrared heater.

If the heater 800 is a high-frequency electric heater, the heater 800 heats the main disc 500 using electromagnetic induction of high-frequency current.

In this case, the heater 800 may include a helical induction coil through which high-frequency current flows, a high-frequency power source (not shown) to apply high-frequency current to the induction coil, and a cooler (not shown) to cool the induction coil.

With the high-frequency electric heating, a uniform high-frequency magnetic field may be created around the main disc 500.

In this case, a surface temperature of the main disc 500 may be changed according to a distance between turns of the induction coil and/or a distance between the induction coil and the main disc 500.

The heater 800 may be located below the main disc 500 to heat the waters 10 placed on the main disc 500 to a desired deposition temperature.

The main disc 500 may include a seating region where one or more wafers 10 are seated. Also, the main disc 500 may be made of a material capable of being heated to at least 300° C. by high-frequency induction heating (i.e. electromagnetic induction of high-frequency current).

Of course, the main disc 500 is preferably made of a material capable of being heated to a maximum of 1400° C.

In the case of the heater 800 of induction heating type, the cooler may serve to cool the heater 800 in order to prevent overheating of the heater 800.

Also, to prevent heat loss due to the cooling of the heater 800, an insulator 700 may be interposed between the main disc 500 and the heater 800.

The insulator 700 may contain an insulating material. The insulator 700 may take the form of a plate having a central through-hole.

One end of the drive shaft 610 is separably coupled to the main disc 500 present in the reaction space s and the other end of the drive shaft 610 protrudes outward from the chamber 400.

In this case, the other end of the drive shaft 61 penetrates through the bottom of the chamber 400 and is connected to the drive unit 620.

Thus, a through-hole (not shown) may be perforated in the bottom of the chamber 400.

The drive unit 620 provides drive force to drive the drive shaft 610.

The drive force may provide rotational force to rotate the drive shaft 610 and also, may provide vertical movement force to raise or lower the drive shaft 610.

The reason why the drive unit 620 provides vertical movement three to raise or lower the drive shaft 610 will be described hereinafter.

Additionally, a sealing member (not shown), such as a bellows, may be provided around the through-hole to seal the interior of the chamber 400 even during driving of the drive shaft 610.

Here, the drive shaft 610 is preferably made of a material having low thermal conductivity.

Since the main disc 500 is heated by the heater 800 and one end of the drive shaft 610 is coupled to the main disc 500, the drive shaft 610 may cause heat loss of the main disc 500, thus resulting in temperature deviation of the main disc 500.

This is the reason for forming the drive shaft 610 of the material having low thermal conductivity.

Additionally, a gas exhaust unit 900 may be provided at a lower surface of the chamber 400 to exhaust the process gas remaining in the reaction space s of the chamber 400.

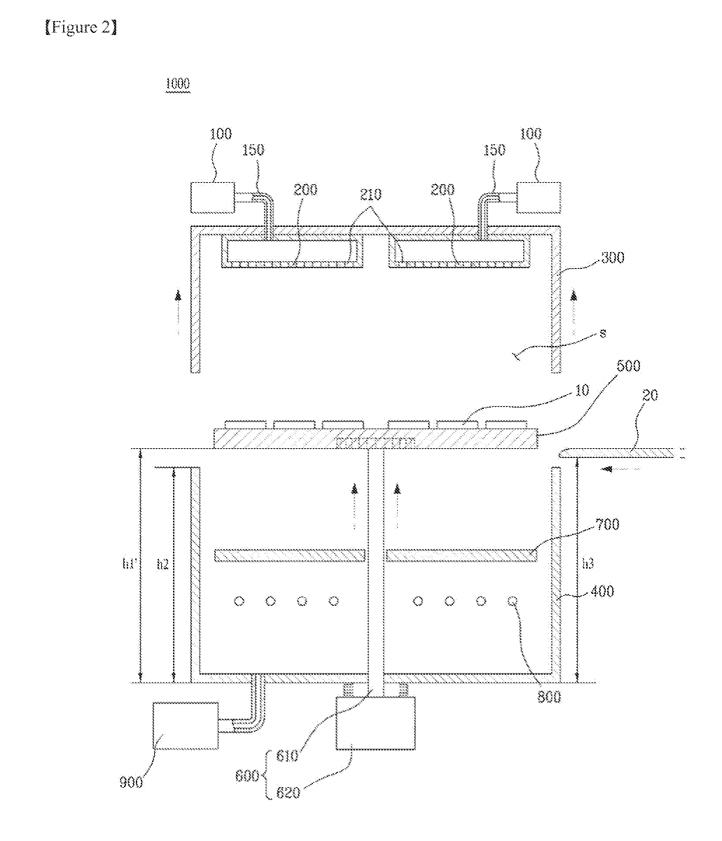

FIG. 2 illustrates another operational state of the substrate processing apparatus 1000 according to the present invention.

Specifically, FIG. 2 illustrates a state in which the lid 300 is opened after completion of deposition in the substrate processing apparatus 1000 illustrated in FIG. 1 and prior to discharging the main disc 500 on which the deposited wafers 10 are seated.

The chamber 400 having the reaction space s of the substrate processing apparatus 1000 has an open top. After completion of deposition, the lid 300 is opened to expose the reaction space s.

To discharge the completely deposited wafers 10 from the substrate processing apparatus 1000, the substrate processing apparatus 1000 is adapted to discharge the entire main disc 5000, rather than individually discharging the wafers 10 or the auxiliary susceptors on which the wafers 10 are seated.

Also, to discharge the main disc 500, instead of providing a lateral surface of the chamber 400 with a slot valve, the lid 300 shielding the reaction space s of the chamber 400 is opened.

However, as illustrated in FIG. 1, a height h2 of an upper end of the chamber 400 may be greater than a height h1 of the lower surface of the main disc 500.

Thus, although a robot arm 20 may be used to raise and discharge the main disc 500 in order to discharge the completely deposited wafers 10, a space between the chamber 400 and the main disc 500 may be insufficient and unnecessarily large space may be required to discharge the main disc 500.

For this reason, as illustrated in FIG. 2, in the substrate processing apparatus 1000 according to the present invention, the drive shaft 610 serves to raise the main disc 500 to facilitate discharge of the main disc 500.

To this end, the drive unit 620 of the substrate processing apparatus 1000 illustrated in FIGS. 1 and 2 needs to provide drive force required to selectively rotate and simultaneously, raise or lower the drive shaft 610.

Specifically, after the main disc 500 is raised such that a height h1 of the lower surface of the main disc 500 is greater than the height h2 of the upper end of the chamber 400, the robot arm 20 is introduced into the chamber 400 at a height h3 (h2<h3<h1), so as to discharge the main disc 500.

As the drive unit 620 raises the drive shaft 610 until the main disc 500 is located higher than the height h2 of the upper end of the chamber 400, the main disc 500 can be discharged when the robot arm 20 is horizontally introduced into the chamber 400.

The drive shaft 610 transmits drive force to the main disc 500 while being separably coupled to the main disc 500.

For example, if a drive gear is mounted on the upper end of the drive shaft 610 and a seating recess, at a lateral surface of which a gear groove is formed, is indented in the lower surface of the main disc 500 for engagement of the drive gear and transmission of rotational drive force therefrom, the main disc 500 can be rotated when the drive shaft 610 is rotated. Once the lower surface of the main disc 500 has been raised by a predetermined height while being supported by the robot arm 20, the main disc 500 can be separated from the drive shaft 610 and be discharged from the chamber 400.

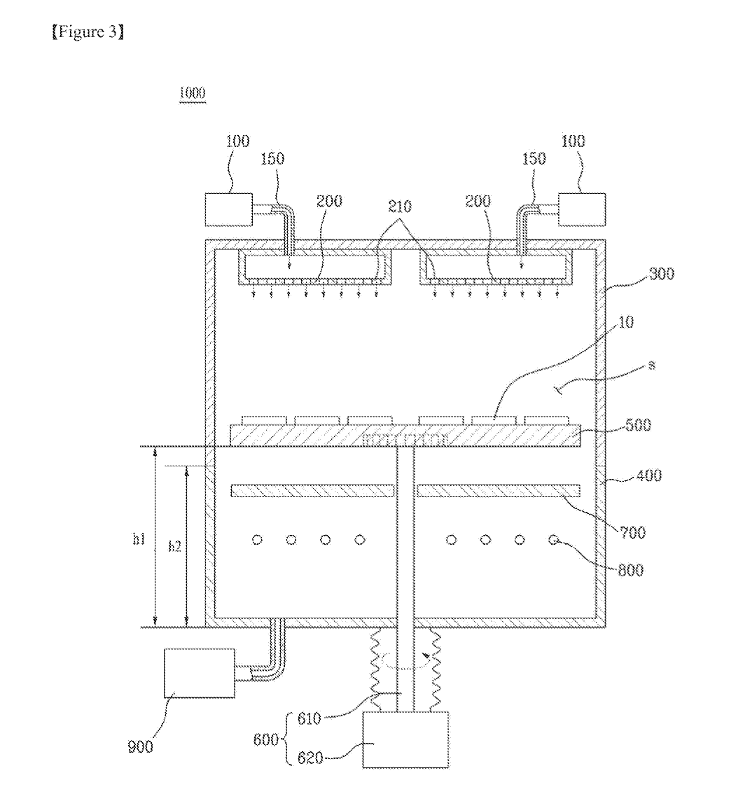

FIG. 3 illustrates another embodiment of the substrate processing apparatus 1000 according to the present invention.

A description overlapped with the description with reference to FIGS. 1 and 2 will be omitted. The substrate processing apparatus 1000 illustrated in FIG. 3 has a feature that a height of the upper end of the chamber 400 is less than a height of the main disc 500 during deposition.

Specifically, if the lid 300 is opened in a state in which the upper end of the chamber 400 is located lower than the main disc 500, raising the main disc 500 using the drive shaft 610 to prepare for discharge the main disc 500 may be omitted.

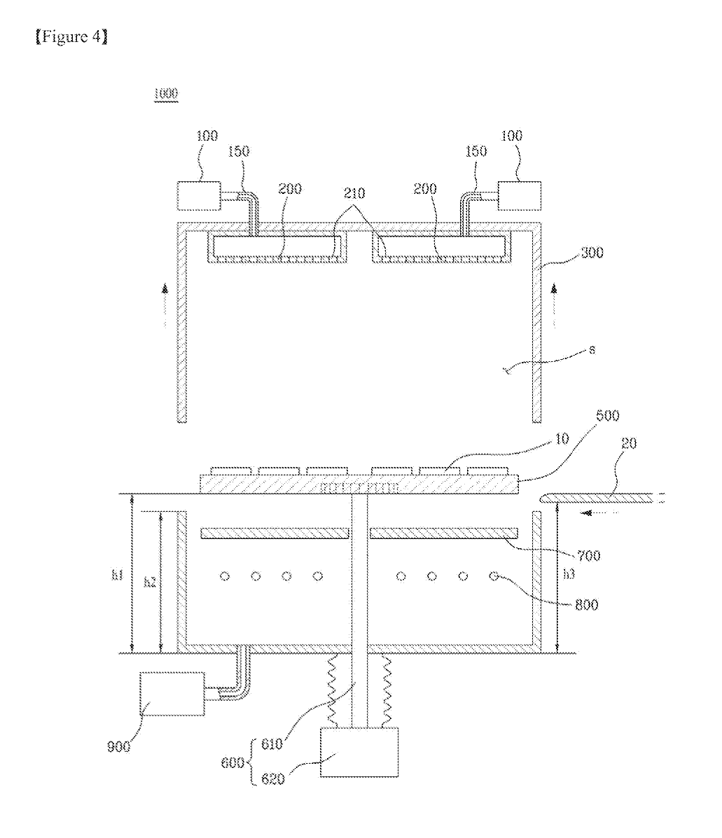

FIG. 4 illustrates another operational state of the substrate processing apparatus 1000 illustrated in FIG. 3.

As illustrated in FIG. 4, when a height h1 of the lower surface of the main disc 500 is greater than a height 112 of the upper end of the chamber 400 in an open state of the lid 300, it is unnecessary to raise the main disc 500 when the robot arm 20 is introduced at a height h3 (h2<h3<h1) to discharge the main disc 500.

Thus, after the lid 300 is opened to expose the reaction space s, the main disc 500 is simply discharged by the robot arm 20.

Specifically, since the introduction height h3 (h2<h3<h1) of the robot arm 20 is greater than the height h2 of the upper end of the chamber 400, the robot arm 20 is simply introduced into the chamber 400 to discharge the main disc 500 after the lid 300 is opened.

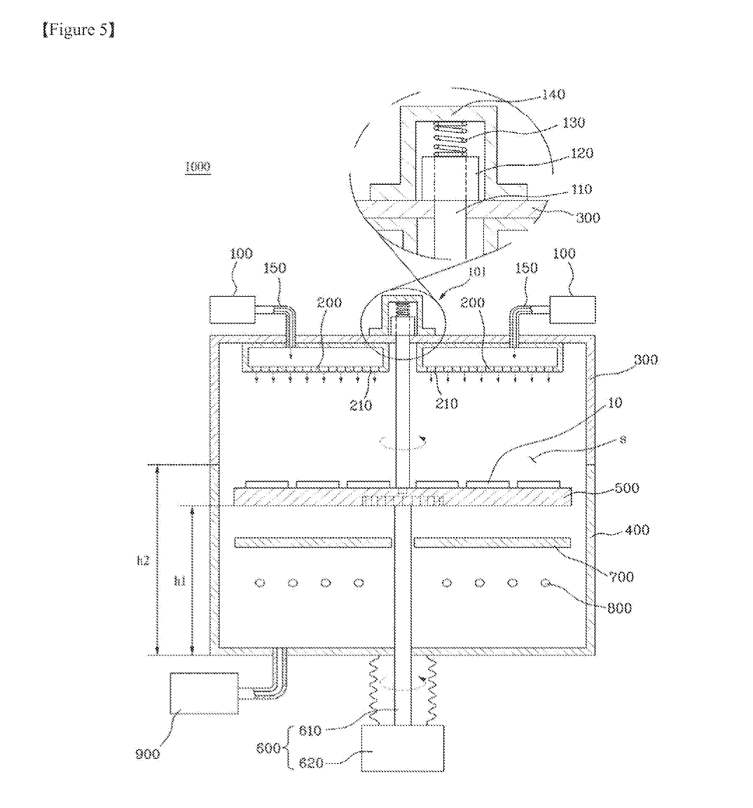

FIG. 5 illustrates another embodiment of the substrate processing apparatus 1000 according to the present invention.

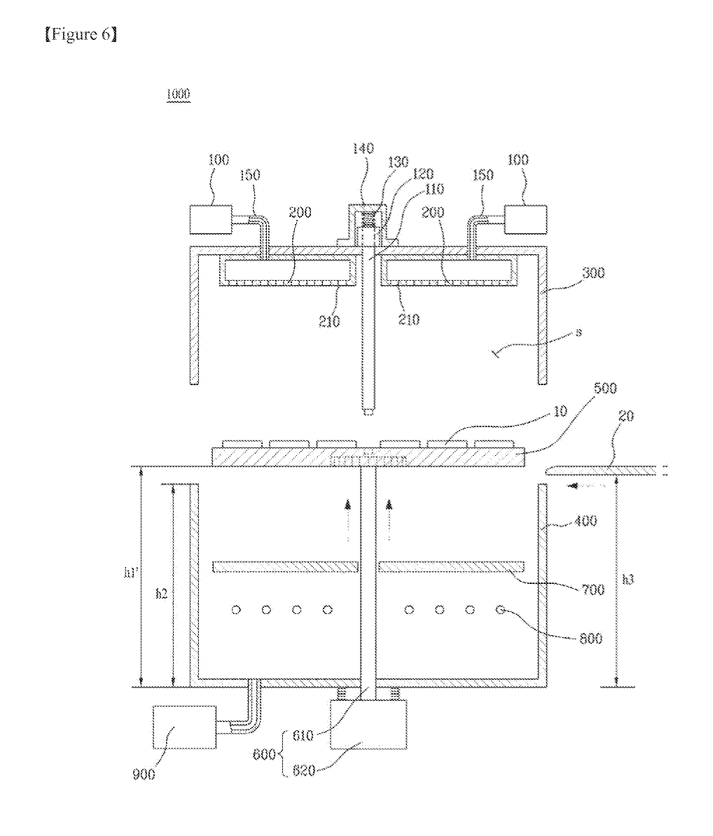

FIG. 6 illustrates another operational state of the substrate processing apparatus 1000 illustrated in FIG. 5. A description overlapped with the description with reference to FIGS. 1 to 4 will be omitted.

Differently from the above described embodiments, the embodiment illustrated in FIG. 5 may further employ a support unit 101, which supports the upper surface of the main disc 500 and is rotated during rotation of the main disc 500.

This serves to ensure driving stability of the main disc 500 when the main disc 500 is driven by the drive shaft 610 during deposition or discharge of the main disc 500.

The support unit 101 includes a support shaft 110 to support the center of the upper surface of the main disc 500, and an elastic member 130 provided at an upper end of the support shaft 110 to restrict support force applied to the main disc 500 by the support shaft 110 while preventing damage to the main disc 500.

The elastic member 130 is mounted in a support cover 140 secured to an upper surface of the lid 300. The upper end of the support shaft 110 is connected to the elastic member 130.

In consideration of the fact that the support shaft 110 may be rotated along with the main disc 500 while supporting the main disc 500, the support unit 101 may further include e.g., a bearing (not shown) and a sealing member lot shown).

Also, to prevent overheating of the elastic member 130, the support unit 101 may further include a cooling member 120. The cooling member 120 may be made of a high specific heat material.

The cooling member 120 may prevent heat from being transferred from the support shaft 110 to the elastic member 130 to some extent.

Even in the embodiment illustrated in FIG. 5, a height h2 of the upper end of the chamber 400 is greater than a height h1 of the lower surface of the main disc 500.

As illustrated in FIG. 6, if the lid 300 is lifted and opened, the support shaft 110, which is mounted to the lid 300 to support the main disc 500, is lifted along with the lid 300.

Also, the drive shaft 610 raises the main disc 500 to prepare for discharge of the main disc 500. That is, after the main disc 500 is raised such that the height h1 of the lower surface of the main disc 500 is greater than the height h2 of the upper end of the chamber 400, the robot arm 20 is introduced into the chamber 400 at the introduction height h3 (h2<h3<h1.), so as to discharge the main disc 500.

Similar to the embodiment illustrated in FIGS. 1 and 2, the main disc 500 can be discharged as the drive unit 620 raises the drive shaft 610 such that the lower surface of the main disc 500 is located higher than the upper end of the chamber 400 and the robot arm 20 is horizontally introduced into the chamber 400.

The support shaft 110 of the support unit 101 is separated from the main disc 500 and lifted along with the lid 300 when the lid 300 is opened, which enables discharge of the main disc 500.

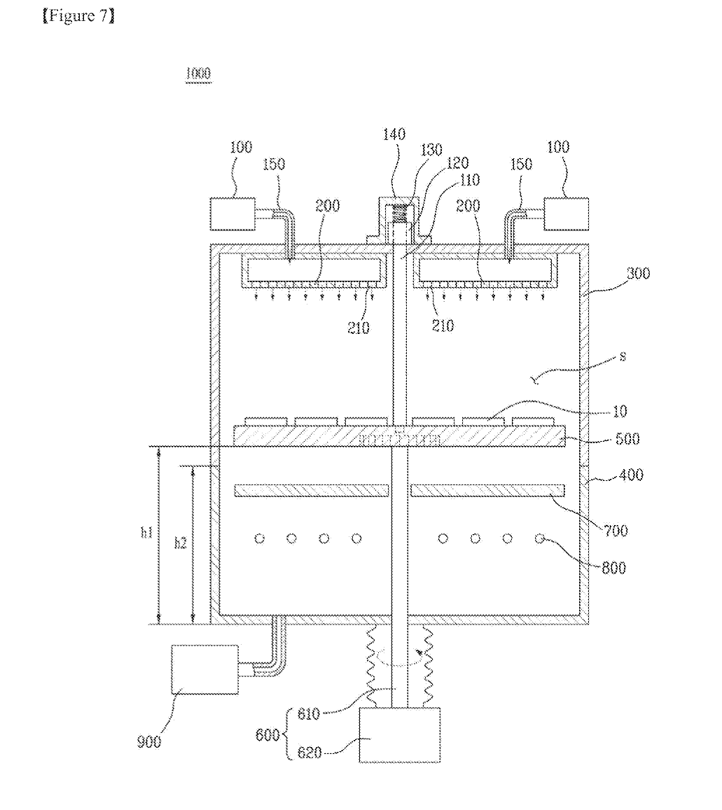

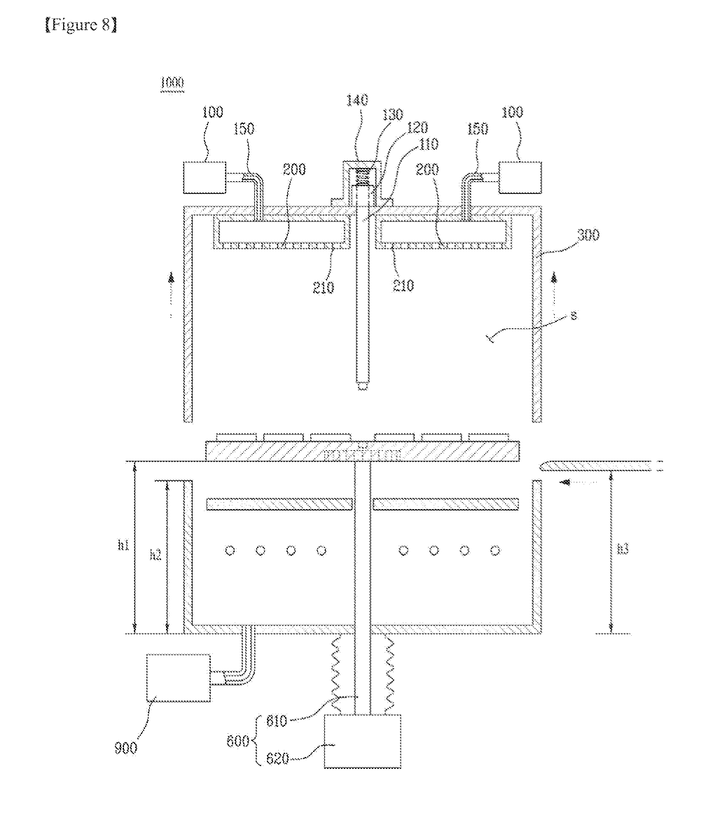

FIG. 7 illustrates another embodiment of the substrate processing apparatus 1000 according to the present invention, and FIG. 8 illustrates another operational state of the substrate processing apparatus 1000 illustrated in FIG. 7. A description overlapped with the description with reference to FIGS. 1 to 6 will be omitted.

Similar to the embodiment illustrated in FIGS. 3 and 4, but differently from the embodiment illustrated in FIGS. 5 and 6, the embodiment illustrated in FIGS. 7 and 8 have a feature that the upper end of the chamber 400 is located lower than the lower surface of the main disc 500.

Similarly, as the lid 300 is lifted and opened after completion of deposition, the support shaft 110 coupled to the lid 300 is separated from the upper surface of the main disc 500.

Thus, if the lid 300 is opened under the condition that a height 112 of the upper end of the chamber 400 is less than a height of the lower surface of the main disc 500, raising the main disc 500 using the drive shaft 610 to prepare for discharge of the main disc 500 may be omitted.

As illustrated in FIG. 8, since the height h1 of the lower surface of the main disc 500 is greater than the height h2 of the upper end of the chamber 400 in an open state of the lid 300, it is unnecessary to raise the main disc 500 to prepare for discharge of the main disc 500 using the robot arm 20.

Thus, after the lid 300 is opened to expose the reaction space s, the robot arm 20 is introduced into the chamber 400 at an introduction height h3 which is greater than the height h2 of the upper end of the chamber 400 and lower than the height h1 of the lower surface of the main disc 500 (h2<h3<h1), enabling discharge of the main disc 500.

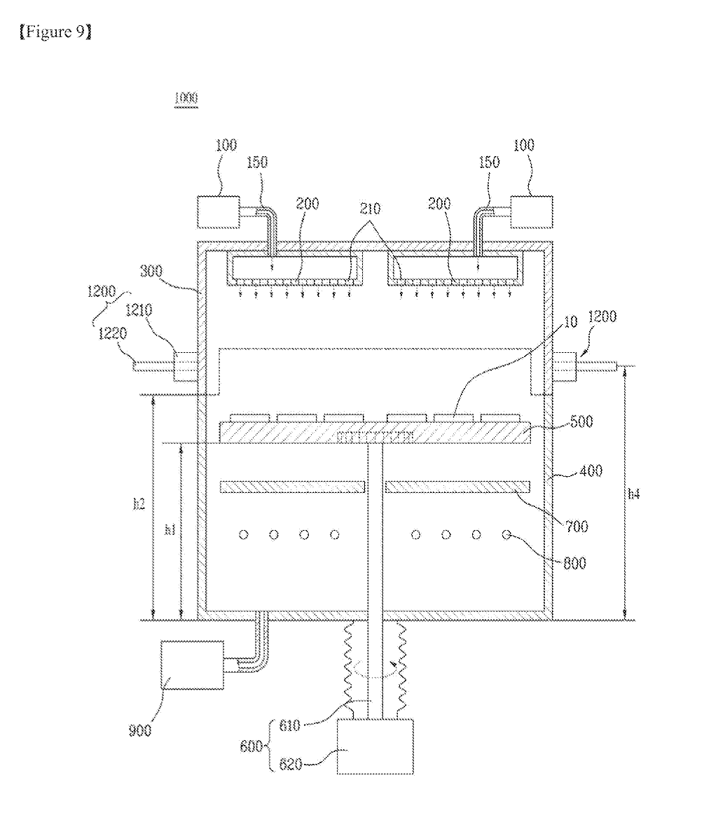

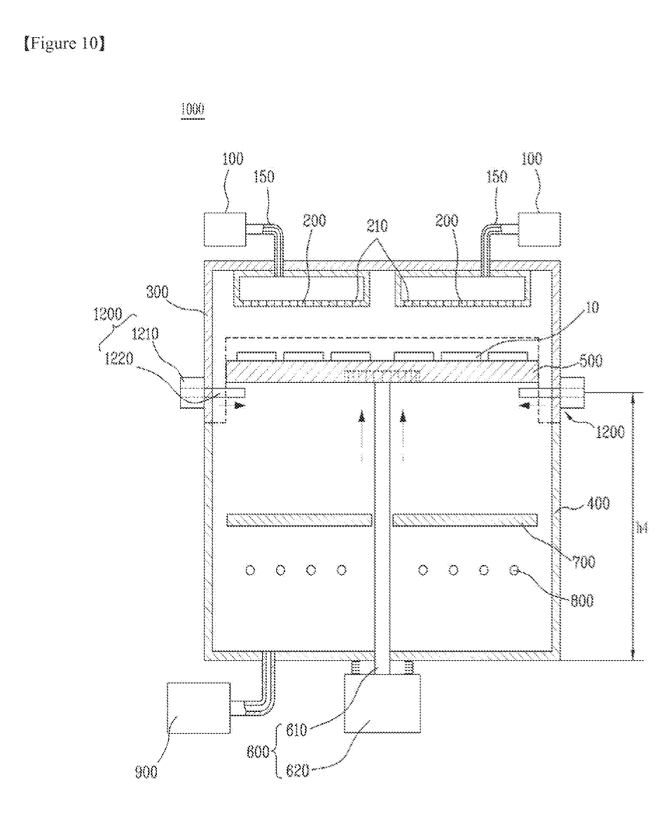

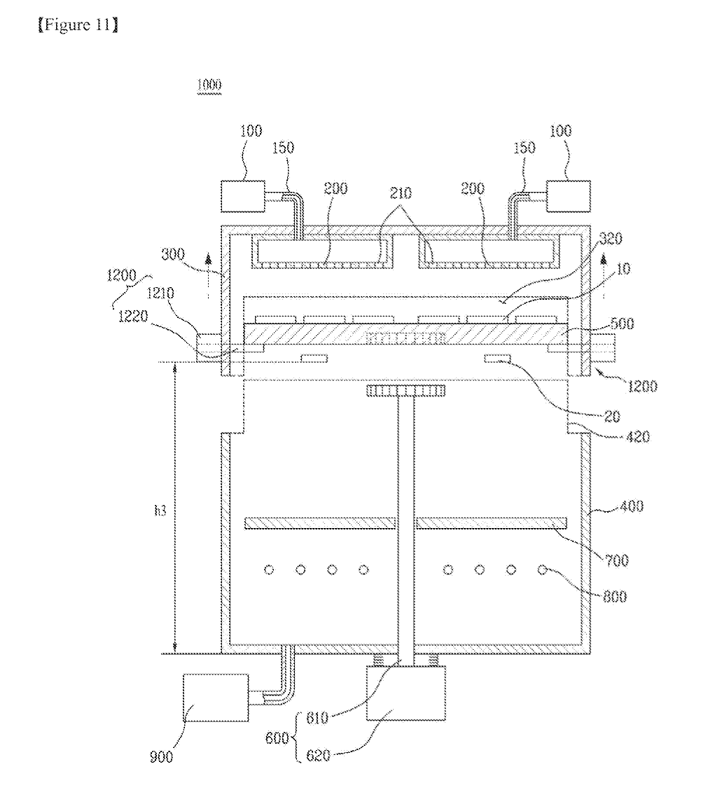

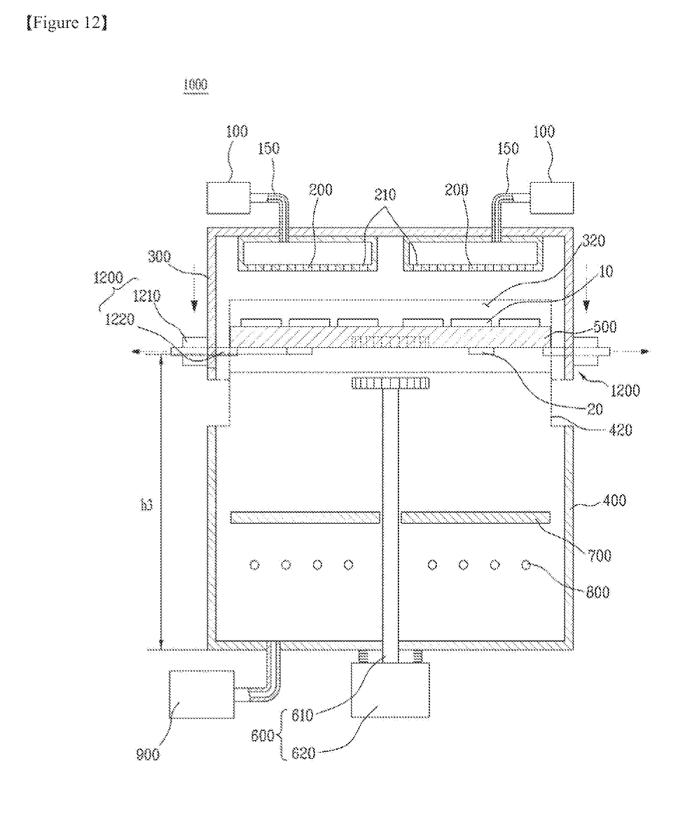

FIG. 9 illustrates another embodiment of the substrate processing apparatus 1000 according to the present invention. FIG. 10 illustrates another operational state of the substrate processing apparatus 1000 illustrated in FIG. 9, FIG. 11 illustrates another operational state of the substrate processing apparatus 1000 illustrated in FIG. 9, and FIG. 12 illustrates another operational state of the substrate processing apparatus 1000 illustrated in FIG. 9.

A description overlapped with the description with reference to FIGS. 1 to 8 will be omitted.

The substrate processing apparatus 1000 according to the present invention further includes the lid 300 provided on the chamber 400 to selectively open or close the reaction space s. The lid 300 may be configured to pull the main disc 500 to a position higher than the upper end of the chamber 400 for discharge of the main disc 500.

In the embodiment illustrated in FIG. 9, the lid 300 to selectively open or close the reaction space s within the chamber 400 includes at least one grip unit 1200 to selectively grip the lower surface of the main disc 500.

The grip unit 1200 may include a grip arm 1220 to selectively protrude toward the lower surface of the main disc 500, and a grip drive unit 1210 to support and move the grip arm 1220.

Here, the grip arm 1220 may selectively protrude to support the lower surface of the main disc 500 only during discharge of the main disc 500, or may be secured to or integrally formed with a lower portion of the lid 300.

The grip drive unit 1210 may be mounted to an inner surface of the lid 300 at a position close to the upper end of the chamber 400, and may provide the grip arm 1220 with drive force required to selectively protrude from the inner surface of the lid 300.

The kind of the grip drive unit 1210 is not specifically limited so long as it provides drive force to selectively protrude the grip arm 1220.

In the substrate processing apparatus 1000 illustrated in FIG. 9, since the height h2 of the upper end of the chamber 400 is greater than the height h1 of the lower surface of the main disc 500 during deposition, it is necessary to raise the main disc 500 to a predetermined height or more within the chamber 400 to prepare for discharge of the main disc 500.

As illustrated in FIG. 10, in a discharge preparation stage of the main disc 500 after completion of deposition, the main disc 500 may be raised in the reaction space s as the drive shaft 610 is driven to be raised.

Once the main disc 500 has been raised higher than a protruding height h4 of the grip arm 1220, the grip arm 1220 provided at the lid 300 may be driven to protrude toward the lower surface of the main disc 500.

The reason for selectively protruding the grip arm 1220 is to allow the main disc 500 to be lifted along with the lid 300 when the lid 300 is lifted to open the reaction space s.

As illustrated in FIG. 11, when the lid 300 is lifted and opened, the grip arm 1220 supports the lower surface of the main disc 500, allowing the main disc 500 to be lifted along with the lifted lid 300.

After the main disc 500 is lifted simultaneously with opening of the lid 300 by the grip arm 1220, the introduction height 113 of the robot arm 20 for discharge of the main disc 500 can be determined.

If raising of the main disc 500 fully depends on the drive shaft 610, the main disc 500 may exhibit unstable raising motion and may fail to obtain a sufficient raising height. As illustrated in FIG. 11, allowing the main disc 500 to be lifted by the grip unit 1200 simultaneously with lifting of the lid 300 may ensure that the robot arm 20 can be introduced at a freely determined height.

In addition, once the robot arm 20 has been introduced to support the lower surface of the main disc 500, the grip unit 1200 may be returned to an original position thereof.

As illustrated in FIG. 11, when the robot arm 20 is introduced, the robot arm 20 may be introduced at the height h3 sufficiently spaced apart from the lower surface of the main disc 500 without a risk of interference.

In this case, the robot arm 20 may be moved upward, or the lid 300 may be lowered, to allow the main disc 500 to be seated on the robot arm 20. FIG. 12 illustrates the embodiment as adopting lowering of the lid 300.

Once the main disc 500 has been seated on the robot arm 20, the grip arm 1220 may be retracted to an original position thereof. This serves to prevent interference during discharge of the main disc 500.

In the embodiment illustrated in FIGS. 9 to 12, after completion of deposition, the robot arm 20 to discharge the main disc 500 may be introduced in a direction into the drawing or out of the drawing.

Thus, to allow the robot arm 20 introduced in the direction into the drawing to discharge the main disc 500, the lid 300 may have an opening 320, designated by the dotted line) perforated in a lower portion thereof to have a predetermined height.

The opening 320 is closed by an extended portion 420, designated by the dotted line) provided at the upper end of the chamber 400 during deposition and is exposed to the outside only when the lid 300 is opened.

The opening 320 of the lid 300 may be provided at a position to which the grip arm 1220 cannot reach. Assuming that a minimum number of grip arms 1220 is used and the size of the opening 320 is greater than the size of the main disc 500, the main disc 500 can be discharged by the robot arm 20 introduced in the direction into the drawing.

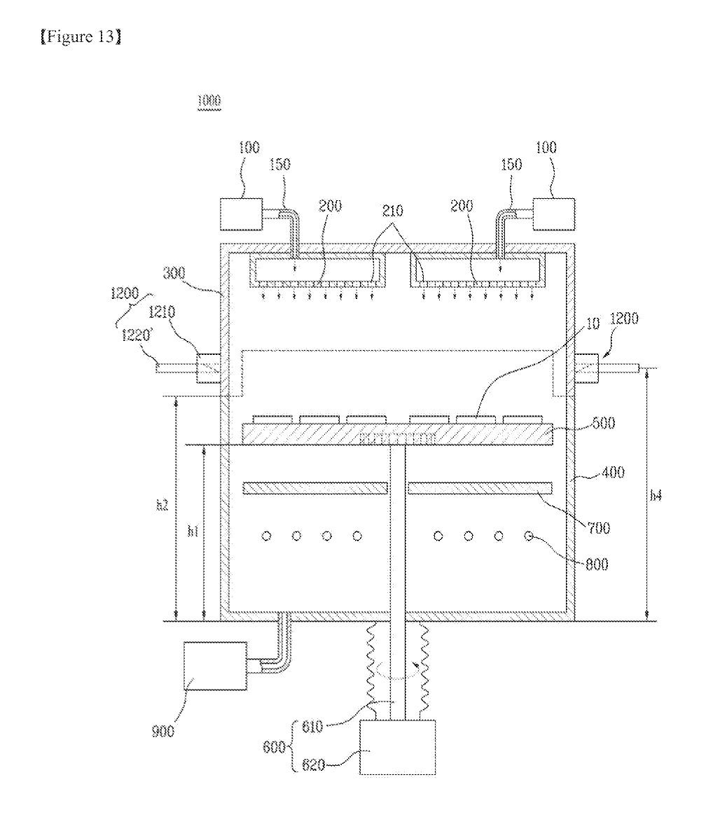

FIG. 13 illustrates another embodiment of the substrate processing apparatus 1000 according to the present invention.

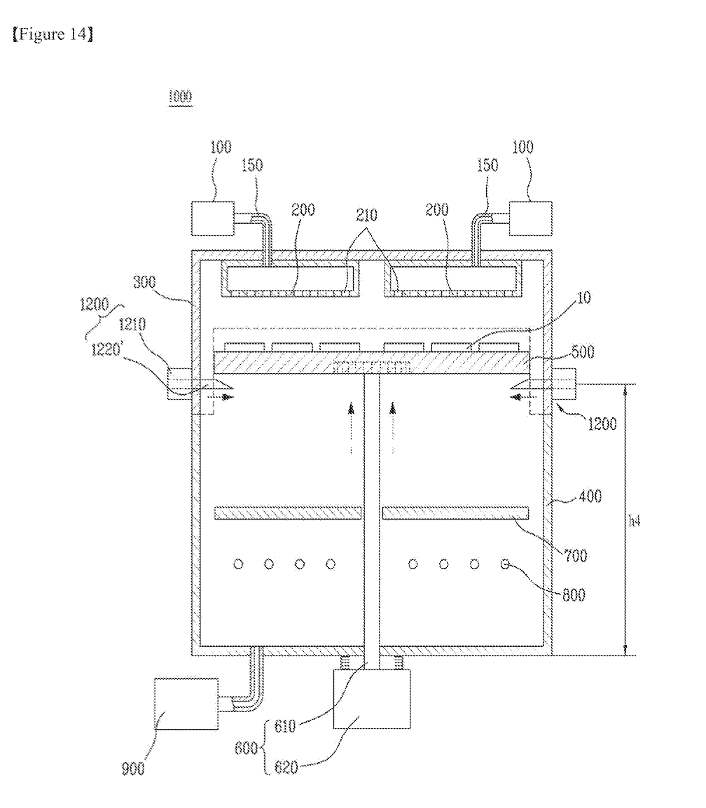

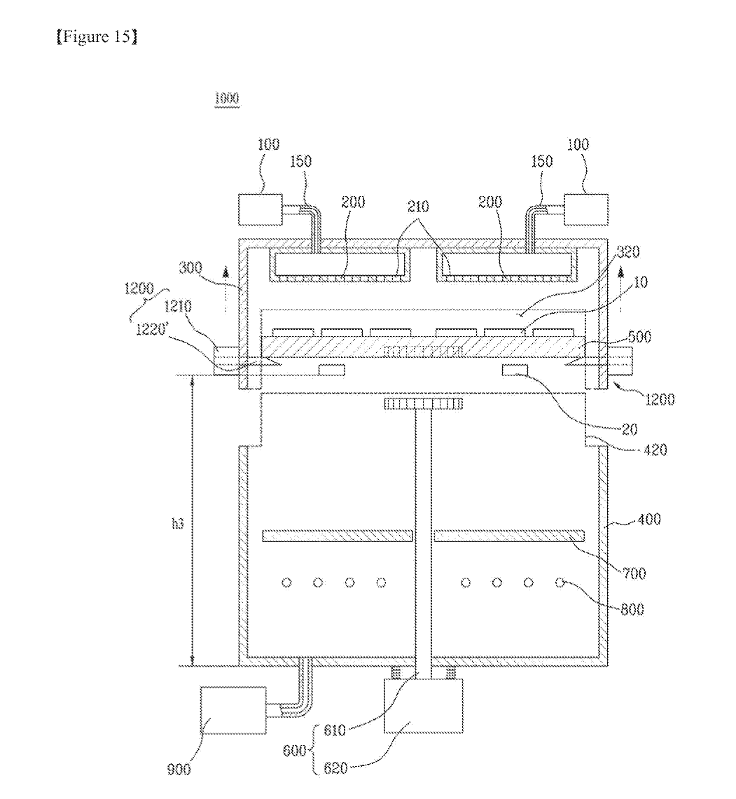

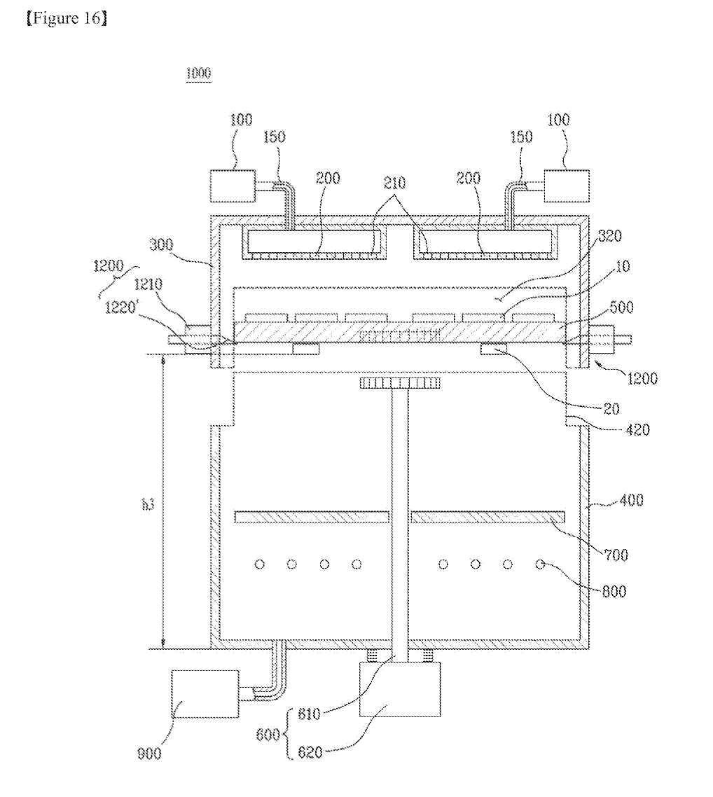

FIG. 14 illustrates another operational state of the substrate processing apparatus 1000 illustrated in FIG. 13, FIG. 15 illustrates another operational state of the substrate processing apparatus 1000 illustrated in FIG. 13, and FIG. 16 illustrates another operational state of the substrate processing apparatus 1000 illustrated in FIG. 13.

Even in the embodiment illustrated in FIGS. 13 to 16, the substrate processing apparatus 1000 according to the present invention further includes the lid 300 provided on the chamber 400 to selectively open or close the reaction space s. The lid 300 may be configured to pull the main disc 500 to a position higher than the upper end of the chamber 400 for discharge of the main disc 500.

The lid 300 to selectively open or close the reaction space s within the chamber 400 includes the at least one grip unit 1200 to selectively grip the lower surface of the main disc 500. The grip unit 1200 may include a grip arm 1220 to selectively protrude toward the lower surface of the main disc 500, and the grip drive unit 1210 to support and move the grip arm 1220′.

The grip arm 1220′ may selectively protrude to support the lower surface of the main disc 500 only during discharge of the main disc 500. Similar to the embodiment illustrated in FIGS. 9 to 12, the grip drive unit 1210 may be mounted to the inner surface of the lid 300 at a position close to the upper end of the chamber 400, and may provide the grip arm 1220′ with drive force required to selectively protrude from the inner surface of the lid 300.

In the substrate processing apparatus 1000 illustrated in FIG. 13, since a height h2 of the upper end of the chamber 400 is greater than a height h1 of the lower surface of the main disc 500 during deposition, it is necessary to raise the main disc 500 to a predetermined height or more within the chamber 400 to prepare for discharge of the main disc 500.

As illustrated in FIG. 14, in a discharge preparation stage of the main disc 500 after completion of deposition, the main disc 500 may be raised in the reaction space s as the drive shaft 610 is driven to be raised.

Once the main disc 500 has been raised higher than the protruding height h4 of the grip arm 1220′, the grip arm 1220′ provided at the lid 300 may be driven to protrude toward the lower surface of the main disc 500.

As illustrated in FIG. 15, when the lid 300 is lifted and opened, the grip arm 1220′ supports the lower surface of the main disc 500, allowing the main disc 500 to be lifted along with the lifted lid 300, similar to the above described embodiment.

The embodiment illustrated in FIGS. 13 to 16 differs from the embodiment illustrated in FIGS. 9 to 12 with regard to the shape of the grip arm and the discharge of the main disc.

As illustrated in FIG. 13, the grip arm 1220′ may be shaped such that a horizontal width of an upper surface is greater than a horizontal width of a lower surface. With this configuration, the grip arm 1220′ may have an inclined lateral surface.

Specifically, the grip arm 1220′ may be pointed in a protruding direction thereof. This shape of the grip arm 1220′ may have the effect of minimizing shock caused when the main disc 500 is seated on the robot arm 20 for discharge thereof.

Differently from the above described embodiment, in a state in which the drive shaft 610 raises the main disc 500 (see FIG. 14) and the grip arm 1220′ supports the lower surface of the main disc 500 (see FIG. 15), the robot arm 20 is introduced at a predetermined height h3 and then, as illustrated in FIG. 16, the grip arm 1220′ is retracted, allowing the main disc 500 to be smoothly moved onto the robot arm 20 along the inclined lateral surface of the grip arm 1220′.

In the embodiment illustrated in FIGS. 13 to 16, differently from the embodiment illustrated in FIGS. 9 to 12, lowing of the lid 300 in a state in which the lid 30 grips the main disc 500 to seat the main disc 500 on the robot arm 20 used to discharge the main disc 500 may be omitted, resulting in enhanced discharge efficiency of the main disc 500.

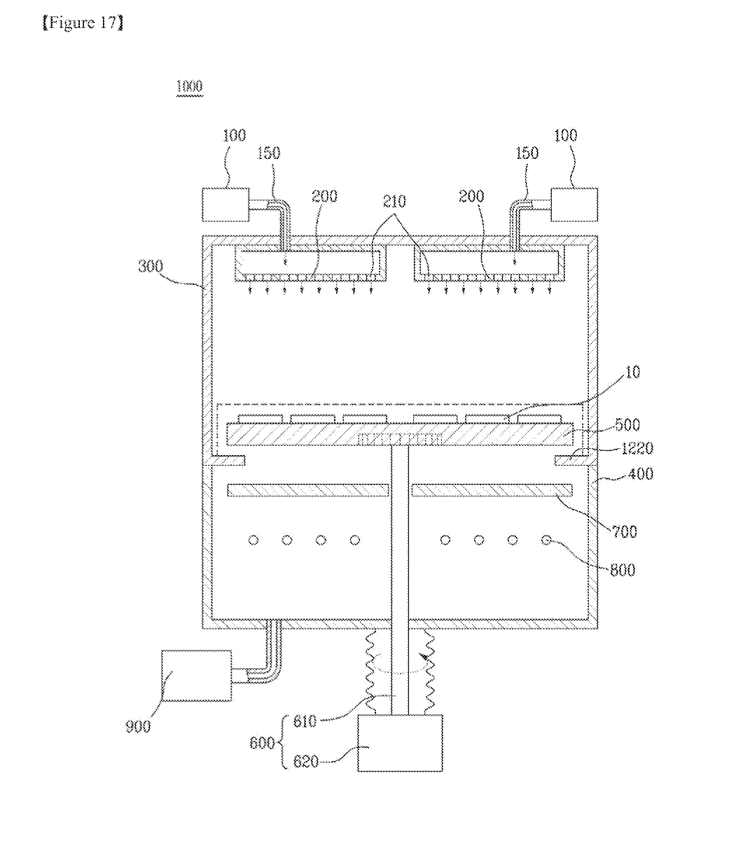

FIG. 17 illustrates another embodiment of the substrate processing apparatus 1000 according to the present invention.

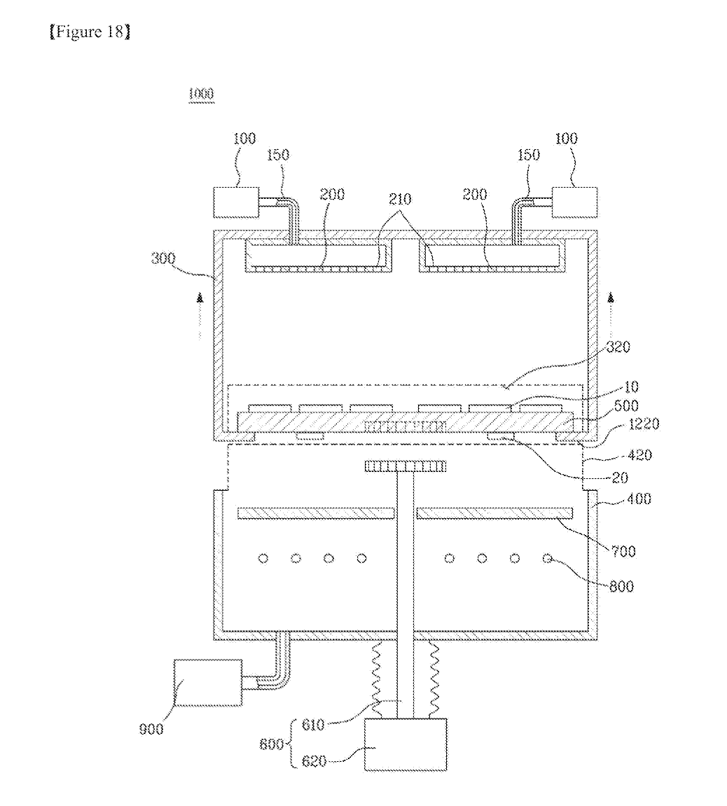

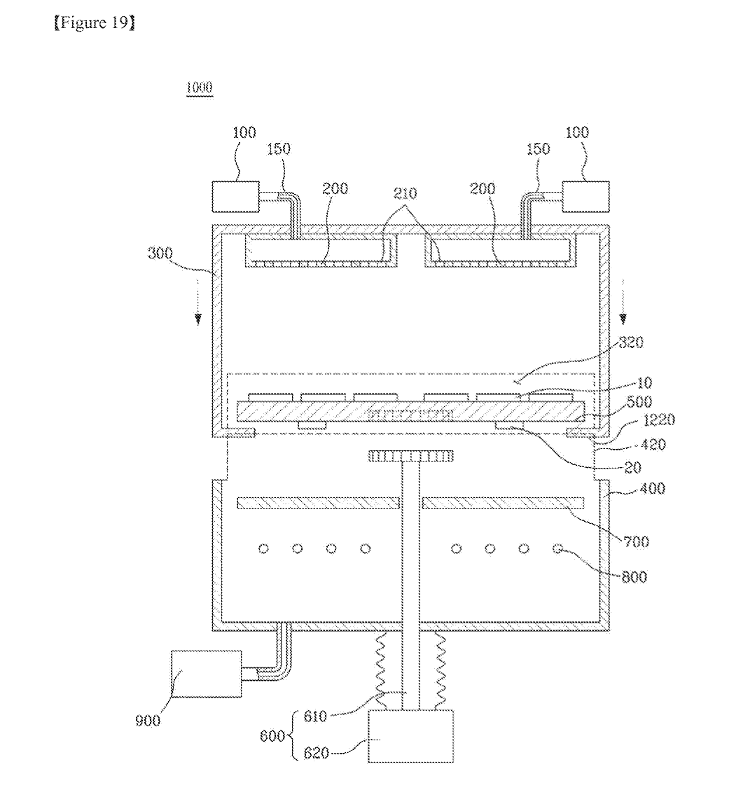

FIG. 18 illustrates another operational state of the substrate processing apparatus 1000 illustrated in FIG. 17, and FIG. 19 illustrates another embodiment of the substrate processing apparatus 1000 illustrated in FIG. 17.

A description overlapped with the description with reference to FIGS. 1 to 16 will be omitted.

Specifically, in the embodiment illustrated in FIG. 17, the grip arm 1220 provided at the lid 300 may be secured to the lid 300. The grip arm 1220 may be integrally formed with the lid 300, or may be previously fabricated separately from the lid 300 and then, fastened thereto.

In the present embodiment, a plurality of grip arms 1220 may be spaced apart from one another by a predetermined distance on a lower end surface of the lid 300.

The substrate processing apparatus 1000 illustrated in FIG. 17, differently from the substrate processing apparatus 1000 illustrated in FIGS. 9 to 16, may omit raising of the main disc 500 by the drive shaft 610 to prepare for discharge of the main disc 500.

As illustrated in FIG. 17, if the main disc 500 is rotated by the drive shaft 610, the grip arm 1220 is spaced apart from the lower surface of the main disc 500 so as not to interfere with rotation of the main disc 500.

That is, when the upper end of the chamber 400 of the substrate processing apparatus 1000 is located lower than the main disc 500 and the grip arm 1220 is secured to the lower end of the lid 300, as illustrated in FIG. 18, the main disc 500 can be lifted along with the lid 300 when the lid 300 is lifted to be opened.

As illustrated in FIG. 18, after the lid 300, by which the main disc 500 has been caught, is lifted and the robot arm 20 accesses the lower surface of the main disc 500, the main disc 500 is seated on an upper surface of the robot arm 20 via upward movement of the robot arm 20 or lowering of the lid 300.

Thereafter, as illustrated in FIG. 19, the lid 300 is lowered to a predetermined height, which can prevent friction between the grip arm 1220 and the main disc 500 caused when the main disc 500 is discharged by the robot arm 20.

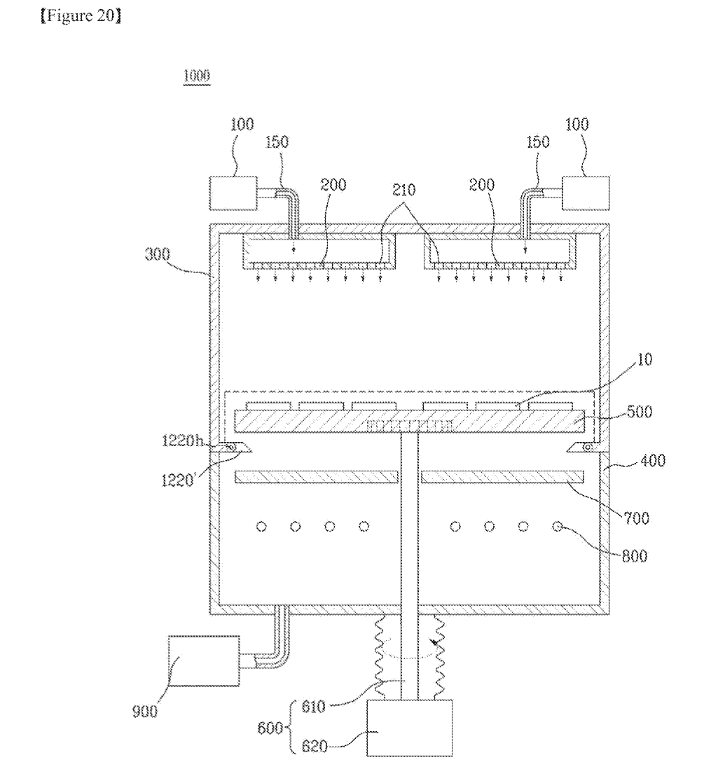

FIG. 20 illustrates another embodiment of the substrate processing apparatus 1000 according to the present invention.

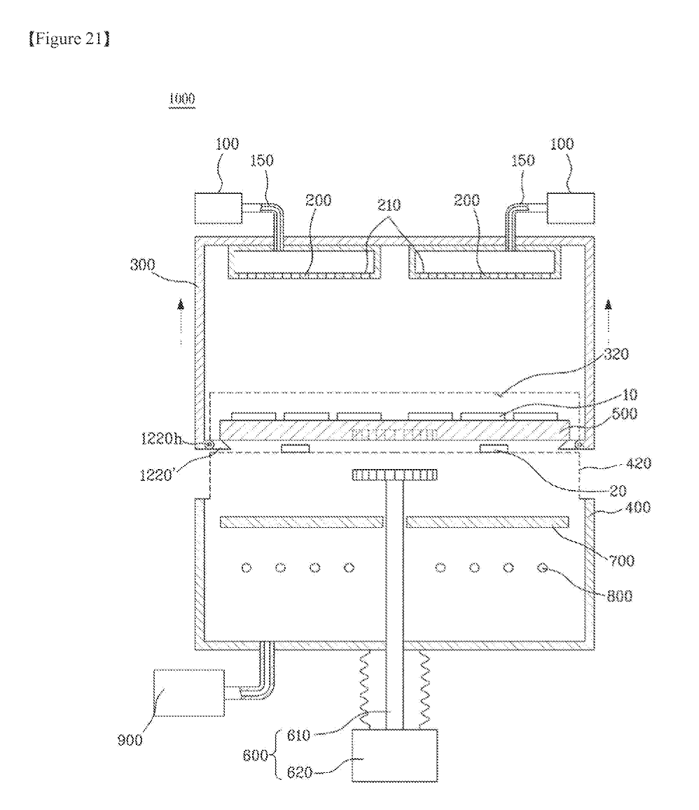

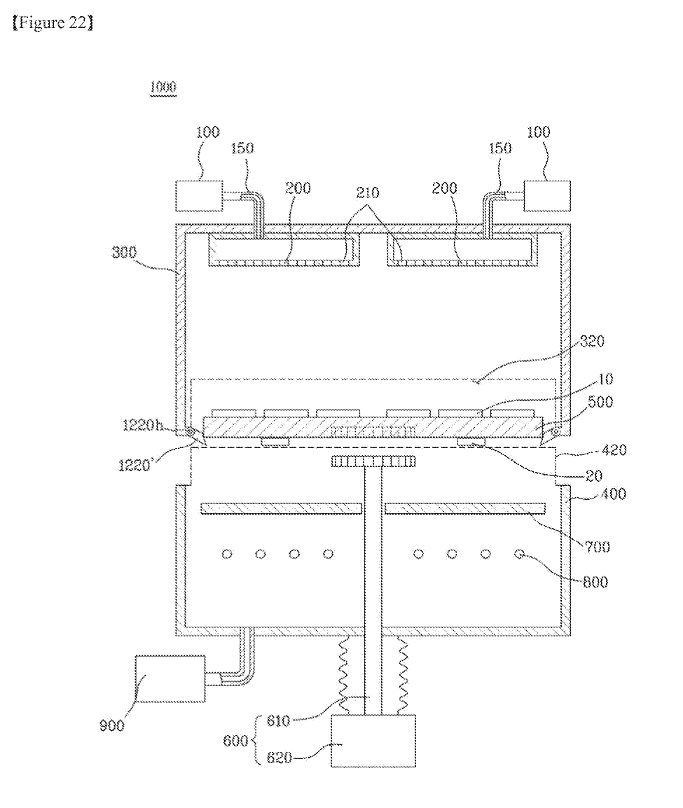

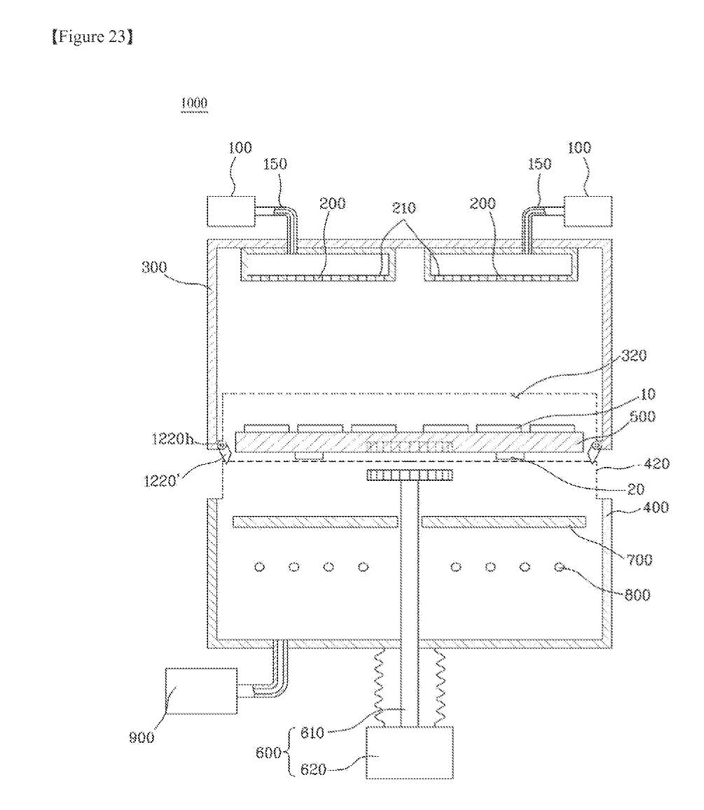

FIG. 21 illustrates another operational state of the substrate processing apparatus 1000 illustrated in FIG. 20, FIG. 22 illustrates another operational state of the substrate processing apparatus 1000 illustrated in FIG. 20, and FIG. 23 illustrates another operational state of the substrate processing apparatus 1000 illustrated in FIG. 20.

In the embodiment illustrated in FIG. 20, the grip arm 1220′ may be rotatably provided at the lid 300. Specifically, the grip arm 1220′ may be downwardly rotatably coupled to the lid 300 via a hinge 1220h.

In the present embodiment, a plurality of grip arms may be provided at a lower position of the lid 300, for example, at the lower end surface of the lid 300.

In the substrate processing apparatus 1000 illustrated in FIG. 20, if the lid 300, by which the main disc 500 has been caught, is lifted to open the reaction space s, as illustrated in FIG. 21, the robot arm 20 may access the lower surface of the main disc (see FIG. 20).

To allow the main disc 500 to be seated on the robot arm 20, first, as illustrated in FIG. 22, the grip arm 1220′ is pivotally rotated downward, causing a distance between the robot arm 20 and the lower surface of the main disc 500 to be reduced.

Then, as illustrated in HG. 23, once the grip arm 1220′ has been completely rotated downward, the main disc 500 is released from the grip arm 1220′ and thus, the main disc 500 can be seated on the robot arm 20 without upward movement of the robot arm 20 or towering of the lid 30.

In the embodiment illustrated in FIGS. 20 to 23, the grip arm 1220′ may have the same shape as that illustrated in FIGS. 13 to 16. Specifically, the grip arm 1220′ is configured such that a horizontal width of the upper surface is less than a horizontal width of the lower surface to provide the grip arm 1220′ with an inclined lateral surface.

This shape can minimize shock or vibration caused when the main disc 500 is seated on the robot arm 20.

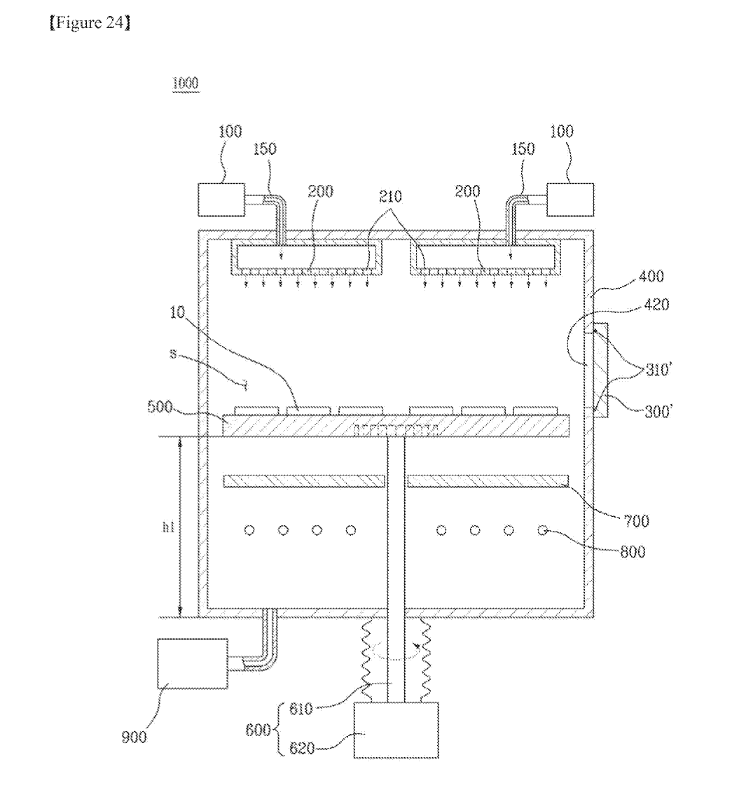

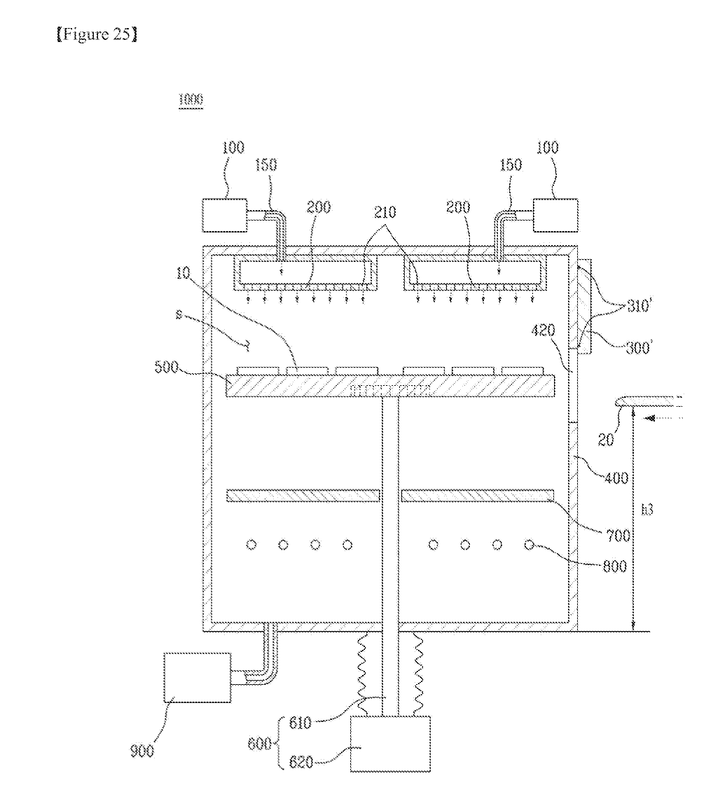

FIG. 24 illustrates another embodiment of the substrate processing apparatus 1000 according to the present invention. FIG. 25 illustrates another operational state of the substrate processing apparatus 1000 illustrated in FIG. 24.

The substrate processing apparatus 1000 illustrated in FIG. 24 includes the chamber 400 having the reaction space s, the main disc 500 accommodated in the chamber 400, on which one or more wafers 10 are placed, and the drive device 600 including the drive shaft 610 to selectively rotate the main disc 500 and the drive unit 620 to drive the drive shaft 610.

The drive shaft 610 is separably coupled to the main disc 500 to transmit drive force thereto. If the lid 300 is opened to expose the reaction space s, the main disc 500, on which the wafers 10 have been placed, is discharged to the outside of the chamber 400, differently from the conventional substrate processing apparatus 1000 in which the wafers 10 or the auxiliary susceptors are discharged individually.

In addition, the chamber 400 having the reaction space s for wafer deposition is opened upon discharge of the main disc 500 in the same manner as that of the above described embodiments.

However, in the embodiment illustrated in FIG. 24, a lateral surface of the chamber 400 may be partially configured to be opened, instead of employing a cover structure, such as a lid, etc., to open the reaction space s of the chamber 400.

To partially open the chamber 400, the chamber 400 may be provided with the opening 420.

To selectively open or close the opening 420 of the chamber 400, a cover member 300′ may be provided at an outer surface of the chamber 400.

The cover member 300′ may be slidably coupled to the outer surface of the chamber 400. The cover member 300′ is provided with a sealing member 310′ to prevent leakage of reaction gas during thin film deposition.

As illustrated in FIG. 25, after completion of deposition, the drive shaft 610 raises the main disc 610 to a height level with the opening 420 and the cover member 300′ slides to open the opening 420, allowing the robot arm 20 to be introduced into the chamber 400 at the predetermined height h3. In this way, discharge of the main disc 500 is possible.

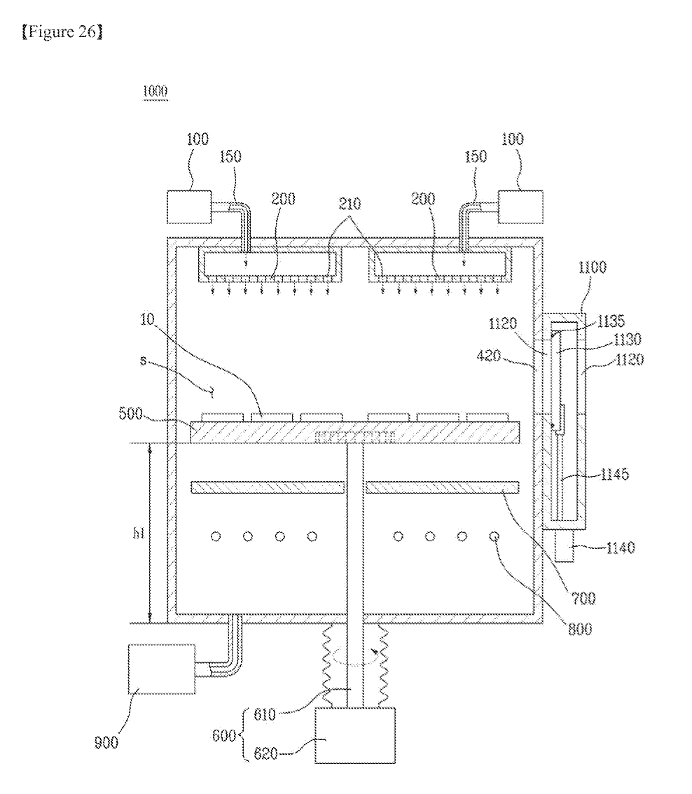

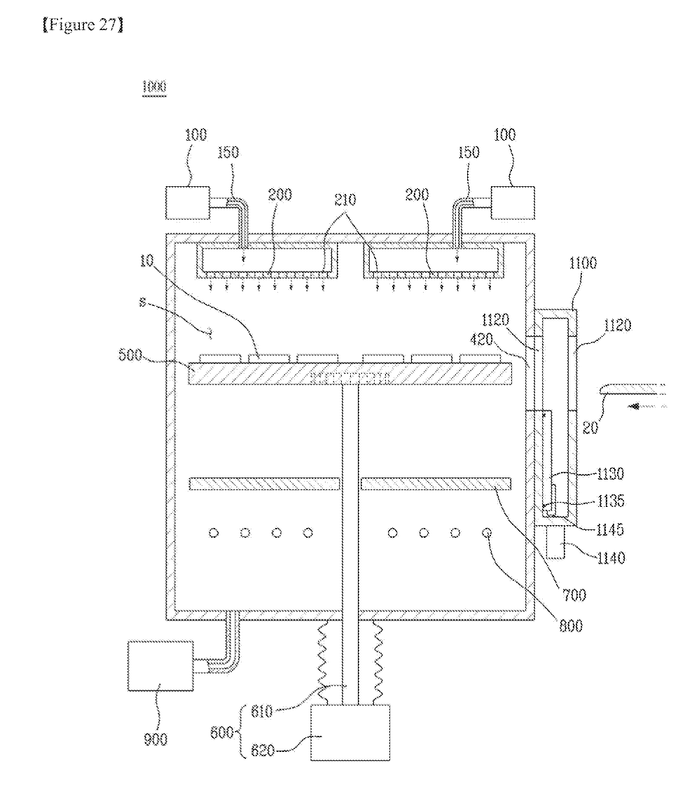

FIG. 26 illustrates another embodiment of the substrate processing apparatus 1000 according to the present invention, and FIG. 27 illustrates another operational state of the substrate processing apparatus 1000 illustrated in FIG. 26.

Similar to the substrate processing apparatus 1000 illustrated in FIGS. 24 and 25, the substrate processing apparatus 1000 illustrated in FIG. 26 is configured such that the lateral surface of the chamber 400 is partially opened, instead of employing the cover structure to open the reaction space s within the chamber 400, such as a lid. The chamber 400 may be provided with the opening 420 to partially open the lateral surface of the chamber 400.

The chamber 400 may be provided at the outer surface thereof with a valve assembly 1100 to selectively open or close the opening 420. The valve assembly 1100 is provided to selectively close the opening 420 of the chamber 400.

The valve assembly 1100 includes a valve housing 1110, and a blade 1130 movably placed in the valve housing 1110 to open or close an opening 1120 perforated in the valve housing 1110.

Here, the opening 1120 serve as an entrance/exit for the main disc 500. The size of the opening 1120 may be determined in consideration of the sizes of the main disc 500 and the robot arm 20.

A valve drive unit 1140 is provided below the valve housing 1110 to drive the blade 1130. A drive shaft 1145 of the valve drive unit 1140 penetrates through the valve housing 1110 and is connected to the blade 1130.

A vertical height of the blade 1130 is greater than a vertical height of the opening 1120. In this case, the term “vertical” is a direction parallel to a movement direction of the blade 1130.

The blade 1130 is provided with a sealing member 1135 at a surface thereof in contact with the valve housing 1110. The sealing member her 1135 may be configured to surround the periphery of the opening 1120.

In this case, the sealing member 1135 may be an O-ring, and a conductive O-ring may be additionally provided.

FIG. 27 illustrates a state in which the blade 1130 is lowered by the valve drive unit 1140 to open the opening 1120.

Although FIG. 26 illustrates two openings 1120 as being perforated in facing walls of the valve housing 1110, the blade 1130 may be provided at only one of the openings 1120.

This is because a vacuum chamber is located toward one opening 1120 to be closed by the blade 1130 and the other opening 1120 not provided with the blade 1130 serves as an entry passage of the robot arm 20 as will be described hereinafter.

If a reaction chamber and a vacuum chamber are located respectively at opposite sides of the valve assembly, the valve assembly may include two blades provided respectively in opposite directions thereof.

Specifically, in the case where the robot arm 20 illustrated in FIG. 27 enters the separate reaction or the vacuum chamber, the blades 1130 may be provided at both the openings 1120 of the valve housing 1110.

With this configuration, the chamber 400 may be more efficiently seated despite provision of the opening for selective discharge of the main disc 500.

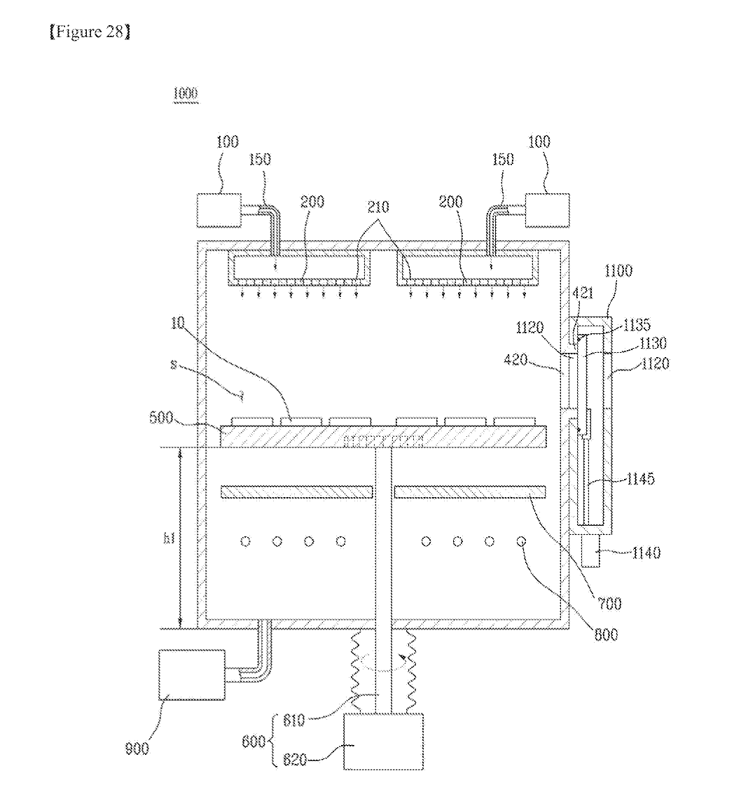

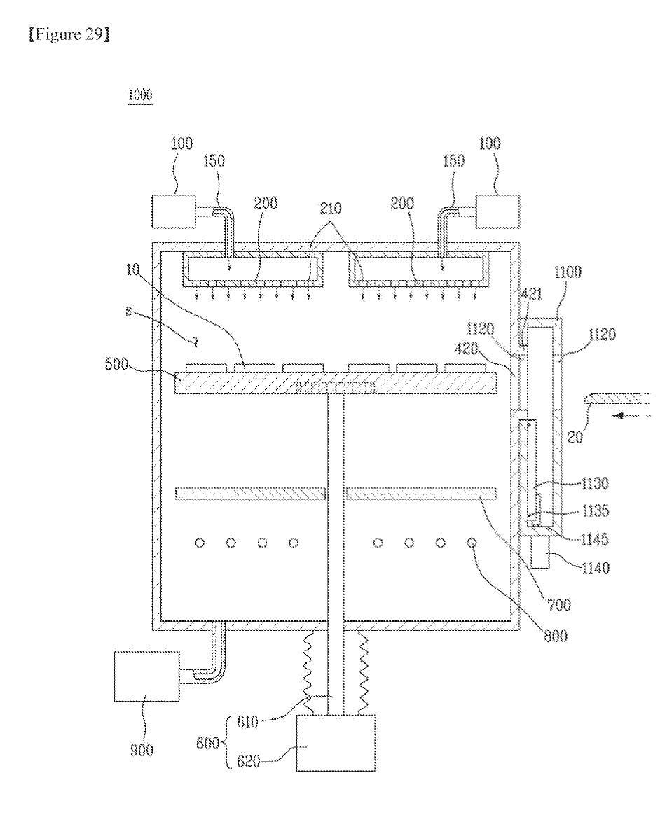

FIG. 28 illustrates another embodiment of the substrate processing apparatus 1000 according to the present invention, and FIG. 29 illustrates another operational state of the substrate processing apparatus 1000 illustrated in FIG. 28. A description overlapped with the description with reference to FIGS. 26 and 27 will be omitted.

The embodiment illustrated in FIGS. 28 and 29 basically corresponds to the embodiment illustrated in FIGS. 26 and 27, and a repeated description thereof will be omitted.

In the embodiment illustrated in FIGS. 28 and 29, the opening 420 of the chamber 400 is provided with an outwardly protruding portion 421.

The outwardly protruding portion 421 is inserted into the opening 1120 of the valve assembly 1100 and is closed by the blade 1130.

Providing the opening 420 with the outwardly protruding portion 421 may achieve improved assembly efficiency with the valve assembly 1100 and superior sealing performance owing to tight engagement.

Thus, the embodiment illustrated in FIGS. 28 and 29 has a feature that the blade 1130 has a different size from that in the embodiment illustrated in FIGS. 26 and 27.

Specifically, in the present embodiment, the vertical height of the blade 1130 may correspond to that of the opening 1120 formed in the valve housing 1100.

The blade 1130 is provided with the sealing member 1135 at the surface thereof in contact with the opening 1120, to completely seal the opening 1120.

The blade 1130 may be driven in a horizontal direction as well as in a vertical direction. This allows the blade 1130 to compress the opening 1120, resulting in enhanced sealing.

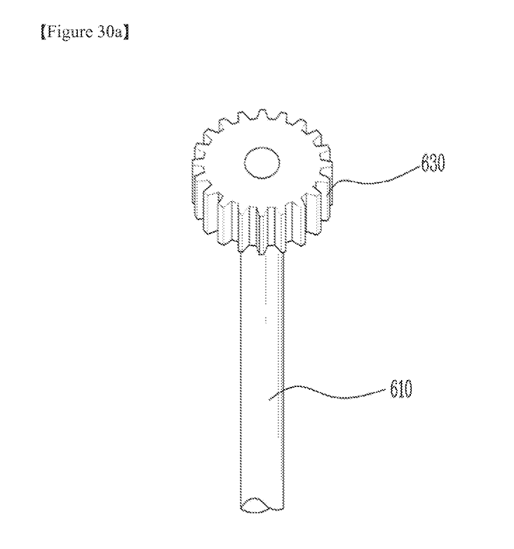

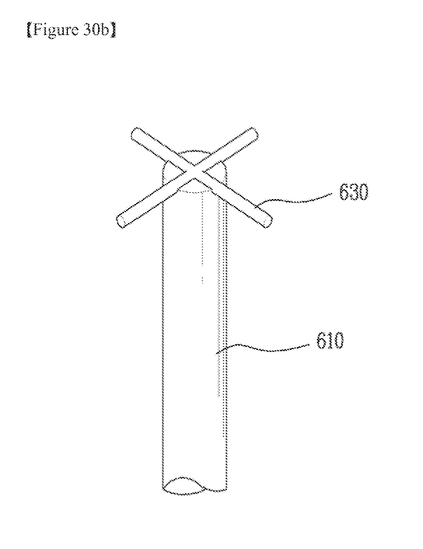

FIGs. 30a and 30b illustrate examples of the drive shaft 610 of the substrate processing apparatus 1000 according to the present invention.

The substrate processing apparatus 1000 according to the present invention has a feature that the entire main disc 500 is discharged after completion of deposition. This is on the assumption that the drive shaft 610 to drive the main disc 500 is separated from the main disc 500 upon discharge of the main disc 500.

Thus, the drive shaft 610 needs to be separably coupled to the lower surface of the main disc 500, to transmit drive force to the main disc 500 upon rotation or vertical movement of the drive shaft 610 and to be separated from the main disc 500 upon discharge of the main disc 500.

The drive shaft 610 illustrated in FIG. 30a is provided at the upper end thereof with a drive gear 630. In this case, the lower surface of the main disc 500 may be provided with an indented portion having a shape corresponding to that of the drive gear 630 to enable engagement therebetween.

The drive gear 630 may transmit rotational drive force to the main disc 500. If the main disc 500 is raised, the drive gear 630 is disengaged from the indented portion, causing the drive shaft 610 to be separated from the main disc 500.

Alternatively, the drive shaft 610 illustrated in FIG. 30b may have a cross-shaped drive bar at the upper end thereof. In this case, the lower surface of the main disc 500 may be provided with a seating recess having a shape corresponding to that of the drive bar for engagement therebetween.

The present invention provides a substrate processing apparatus capable of discharging an entire main disc to the outside of a deposition process chamber.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A substrate processing apparatus comprising:
a chamber having a reaction space;
a lid provided on the chamber to selectively open or close the reaction space;
a main disc accommodated in the chamber, on which at least one wafer is placed; and
a drive device including a drive shaft to selectively rotate the main disc and a drive unit to drive the drive shaft,
wherein the drive shaft is separably coupled to the main disc to transmit drive force, and
wherein when the lid is opened to expose the reaction space, the main disc is separated from the drive shaft and is discharged to the outside of the chamber in a state in which the wafer is placed thereon.

2. The apparatus according to claim 1, wherein the drive unit raises the drive shaft so as to raise the main disc upon discharge of the main disc.

3. The apparatus according to claim 1, wherein when the lid is lifted to open the chamber, the lid grips the main disc so as to be lifted along with the main disc.

4. The apparatus according to claim 3, wherein the lid includes at least one grip unit having a grip arm to selectively grip the main disc.

5. The apparatus according to claim 4, wherein the grip arm is rotatable or horizontally movable to support a lower surface of the main disc.

6. The apparatus according to claim 4, wherein the grip arm is coupled to a lower position of the lid, or is integrally formed with the lid.

7. The apparatus according to claim 1, wherein a height of an upper end of the chamber is less than a height of a lower surface of the main disc.

8. The apparatus according to claim 1, wherein the lid includes a support unit to support an upper surface of the main disc, the support unit being rotated along with the main disc during rotation of the main disc.

9. The apparatus according to claim 8, wherein the support unit includes a support shaft extending from the lid to the upper surface of the main disc, an elastic member to provide the support shaft with elastic force, and a support cover placed on the lid to support the support shaft and the elastic member.

10. The apparatus according to claim 9, wherein the support unit further includes cooling member to cool the support shaft or the elastic member.

11. The apparatus according to claim 1, wherein a drive gear is provided at an upper end of the drive shaft, and a seating recess into which the drive gear is seated is formed in a lower surface of the main disc the seating recess being formed at a lateral surface thereof with a gear groove to be engaged with the drive gear.

12. The apparatus according to claim 1, wherein the lid is provided at a lower end thereof with an opening for introduction of a robot arm upon discharge of the main disc, and the chamber is provided at an upper end thereof with an extended portion to be engaged with the opening so as to close the opening when the lid covers the chamber.

13. The apparatus according to claim 12, wherein the lid includes one or more grip units each having a grip arm to selectively grip the main disc, the grip units being spaced apart from one another on a lateral surface of the lid except for the opening.

14. A substrate processing apparatus comprising:
a chamber having a reaction space for wafer deposition;
a main disc rotatably mounted in the reaction space; and
a drive shaft separably coupled to a lower surface of the main disc to selectively rotate or vertically move the main disc,
wherein the chamber is opened upon discharge of the main disc.

15. The apparatus according to claim 14, wherein if a height of the main disc is less than a height of an upper end of the chamber during wafer deposition, the drive shaft is raised such that the height of the main disc becomes greater than the height of the upper end of the chamber upon discharge of the main disc.

16. The apparatus according to claim 14, further comprising a lid provided on the chamber to selectively open or close the reaction space, the lid serving to pull the main disc to a height higher than the upper end of the chamber upon discharge of the main disc.

17. A substrate processing apparatus comprising:
a chamber having a reaction space and provided at a lateral surface thereof with an opening;
a main disc accommodated in the chamber, on which at least one wafer is placed; and
a drive device including a drive shaft to selectively rotate the main disc and a drive unit to drive the drive shaft,
wherein the drive shaft is separably coupled to the main disc to transmit drive force, and
wherein the main disc is separated from the drive shaft and is discharged to the outside of the chamber through the opening of the chamber in a state in which the wafer is placed thereon.

18. The apparatus according to claim 17, wherein the opening of the chamber is selectively opened or closed by a cover member slidably mounted to the lateral surface of the chamber.

19. The apparatus according to claim 17, further comprising a valve assembly including a valve housing provided at the opening and a blade mounted in the valve housing to selectively open or close the opening of the chamber.

20. The apparatus according to claim 19, wherein the blade of the valve assembly includes a sealing member.
